(19) United States
(12) Patent Application Publication
(10) Pub. No.: US 2011/0017028 A1
(43) Pub. Date: Jan. 27, 2011

(54) BENDING STRUCTURE OF A HAND TOOL

(76) Inventor: Shao-Fan Kuo, Taishan Township (TW)

Correspondence Address: Muncy, Geissler, Olds & Lowe, PLLC, 4000 Legato Road, Suite 310, FAIRFAX, VA, 22033, US

(21) Appl. No.: 12/507,501

(22) Filed: Jul. 22, 2009

(51) Int. Cl. B25B 23/16

(52) U.S. Cl. 81/177.8

(57) ABSTRACT

A bending structure of a hand tool includes a grip part. A bottom rim of an end of the grip part is formed with an actuating slot having an actuating rod. Side walls of an actuating part have respectively a wall pushing the actuating rod away from the actuating slot and a notch receiving the actuating rod in the actuating slot. By the aforementioned structures, a swiveling head can rotate freely or be fixed at a specific position by toggling a knob.

### BACKGROUND OF THE INVENTION

a) Field of the Invention

The present invention relates to a bending structure of a hand tool and more particularly to a bending structure of a hand tool which can allow a swiveling head to rotate freely and to be fixed at a specific position.

b) Description of the Prior Art

A machine is a foundation of manufacturing business, because production of all objects should use a machine. Whereas, a tool is a base of machine business and production of all machines requires using a tool. There are many kinds of tools according to purposes, functions and prices, and each tool is provided with a different function and purpose.

The tool can be divided into an electric tool which uses electricity to produce power, a pneumatic tool which uses air as driving power or even a hand tool which uses man power. Among them, as using the most primitive man power, the hand tool is most popular and is used broadly.

However, when the aforementioned hand tool is in use, following issues and shortcomings actually exist for improvement.

As all kinds of hand tools are designed with various types of corresponding socket joints, such as a screw driver, an F-handle or a sleeve set; therefore, each hand tool is fitted with a corresponding socket joint. Yet, for the conventional hand tool, as an angle is fixed, there will be a spatial place not good for adjustment, which usually results in inconvenience.

### SUMMARY OF THE INVENTION

The primary object of the present invention is to provide a bending structure of a hand tool which can allow a swiveling head to rotate freely and to be fixed at a specific position.

To achieve the aforementioned object, the present invention includes a grip part. A bottom rim of an end of the grip part is formed with an actuating slot, an interior of the actuating slot is slidingly provided with an actuating rod and an end of the actuating rod is formed with a teeth part; whereas, two sides of an end of the grip part are extended respectively with a pivoting part, each pivoting part is opened with a pivot hole in a direction perpendicular to the actuating slot, the pivot holes are pivoted with a swiveling head and a rear end of the swiveling head is formed with a teeth part which can be locked with the actuating rod. A side of the grip part is opened with a control slot, an interior of the control slot contains a knob, the knob includes a toggle part which can rotate the knob and an actuating part, side walls of the actuating part are formed respectively with a wall which can push the actuating rod away from the actuating slot, and a notch which can accommodate an rear end of the actuating rod to receive the actuating rod in the actuating slot.

As the present invention includes the knob which includes the toggle part to rotate the knob and the actuating part, with the side walls of the actuating part being formed respectively with the wall to push the actuating rod away from the actuating slot and the notch to accommodate the rear end of the actuating rod that the actuating rod can be received in the actuating slot, a user can toggle the knob to rotate the swiveling head freely or to fix the swiveling head at a fixed position. When the swiveling head rotates freely, the actuating rod is accommodated in the notch of the actuating slot and the teeth part of the actuating rod is far away from the teeth part of the swiveling head; at this time, the swiveling head can rotate freely. On the other hand, when the swiveling head is fixed at a specific position, the wall of the actuating part pushes the actuating rod and the teeth part of the actuating rod is locked with the teeth part of the swiveling head; at this time, the swiveling head is fixed.

To enable a further understanding of the said objectives and the technological methods of the invention herein, the brief description of the drawings below is followed by the detailed description of the preferred embodiments.

### BRIEF DESCRIPTION OF THE DRAWINGS

FIG. 1 shows a three-dimensional view of a preferred embodiment of the present invention.

FIG. 2 shows a first three-dimensional exploded view of a preferred embodiment of the present invention.

FIG. 2A shows a second three-dimensional exploded view of a preferred embodiment of the present invention.

FIG. 3 shows a cutaway view of a preferred embodiment of the present invention.

FIG. 4 shows a first schematic view of an operation of a preferred embodiment of the present invention.

FIG. 5 shows a second schematic view of an operation of a preferred embodiment of the present invention.

FIG. 6 shows a third schematic view of an operation of a preferred embodiment of the present invention.

FIG. 7 shows a schematic view of an implementation of another preferred embodiment of the present invention.

FIG. 8 shows a schematic view of an implementation of still another embodiment of the present invention.

### DETAILED DESCRIPTION OF THE PREFERRED EMBODIMENTS

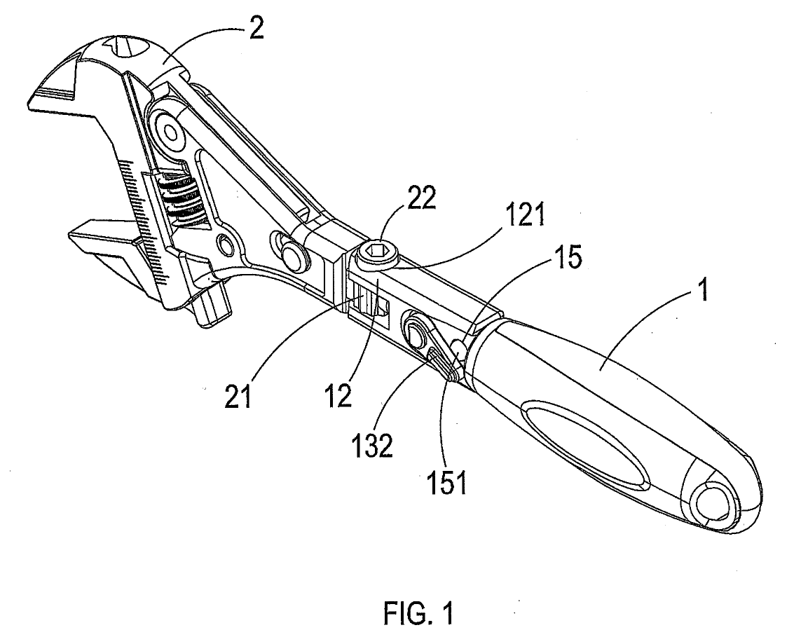

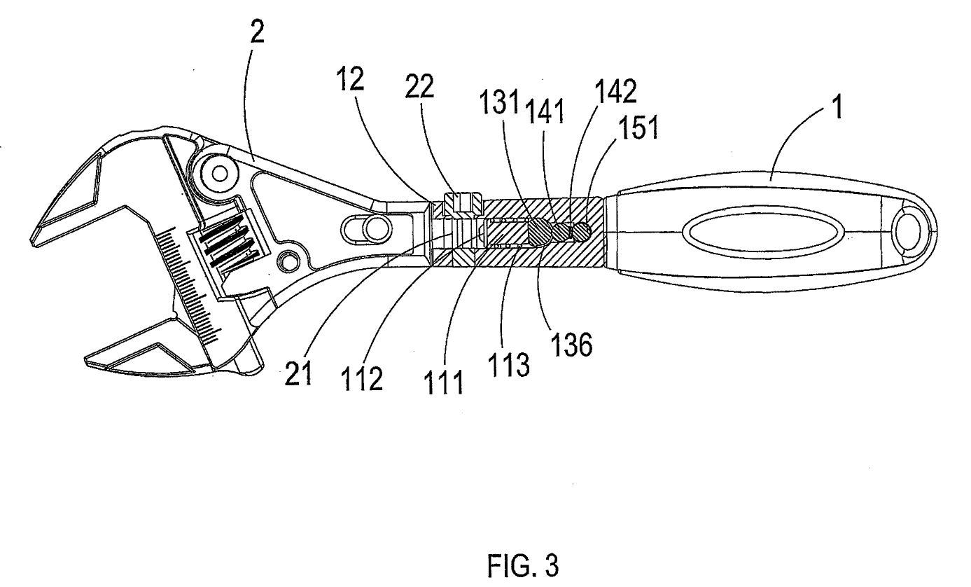

Referring to FIGS. 1, 2, 2A and 3, it shows a three-dimensional view, a first three-dimensional exploded view, a second three-dimensional exploded view and a cutaway view, of a preferred embodiment of the present invention. As shown in the drawing, the present invention comprises a grip part 1, wherein a bottom rim of an end of the grip part 1 is formed with an actuating slot 11, an interior of the actuating slot 11 is slidingly provided with an actuating rod 111 and an end of the actuating rod 111 is formed with a teeth part 112; two sides of an end of the grip part 1 are extended respectively with a pivoting part 12, each pivoting part 12 is opened with a pivot hole 121 in a direction perpendicular to the actuating slot 11, the pivot holes 121 are pivoted with a swiveling head 2 and a rear end of the swiveling head 2 is formed with a teeth part 21 which can be locked with the actuating rod 111; a side of the grip part 1 is opened with a control slot 13, an interior of the control slot 13 is accommodated with a knob 131, the knob 131 includes a toggle part 132 which can rotate the knob 131 and an actuating part 133, side walls of the actuating part 133 are formed respectively with a wall 134 which can push the actuating rod 111 away from the actuating slot 111, and a notch 135 which can accommodate the actuating rod 111, allowing the actuating rod 111 to be received in the actuating slot 11.

In addition, an elastic element 113 is provided between the actuating rod 111 and the actuating part 133, the swiveling head 2 is pivoted at the pivot holes 121 by a screw element 22, the control slot 13 is opened with a locking groove 14 in a direction perpendicular to the inner wall 134, an interior of the locking groove 14 is accommodated with a ball 141 which is abutted with an elastic element 142 and the actuating part 133 is formed with a latching groove 136 to accommodate the ball 141.

The control slot 13 is opened with a locking groove 15 in a direction perpendicular to the inner wall 134, an interior of the locking groove 15 is accommodated with a ball 151 which is abutted with an elastic element 152, and the actuating part 133 is formed with the latching groove 136 to accommodate the ball 151.

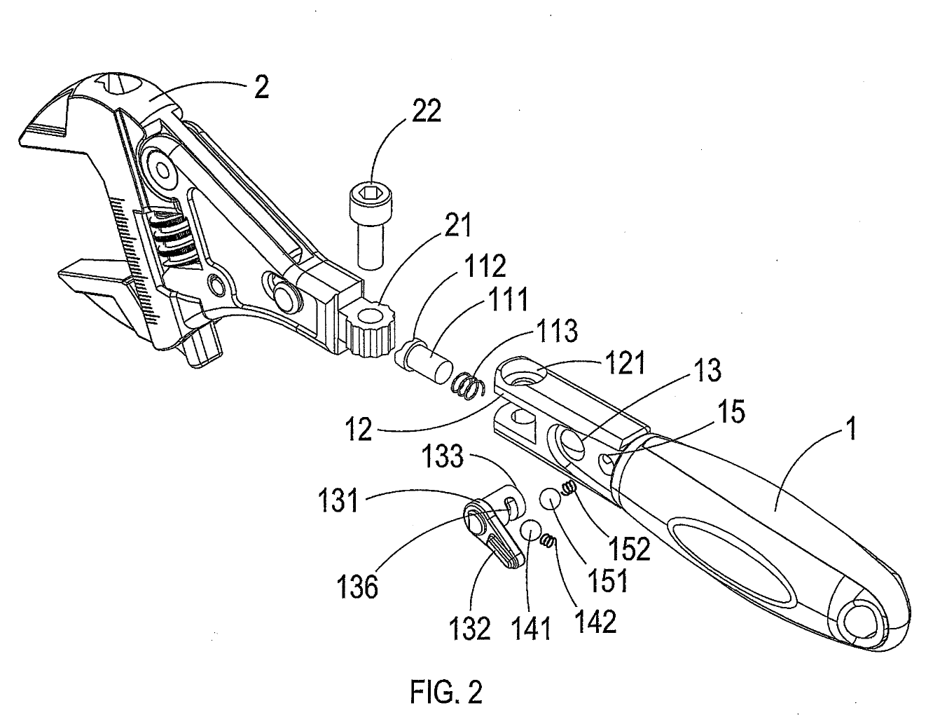

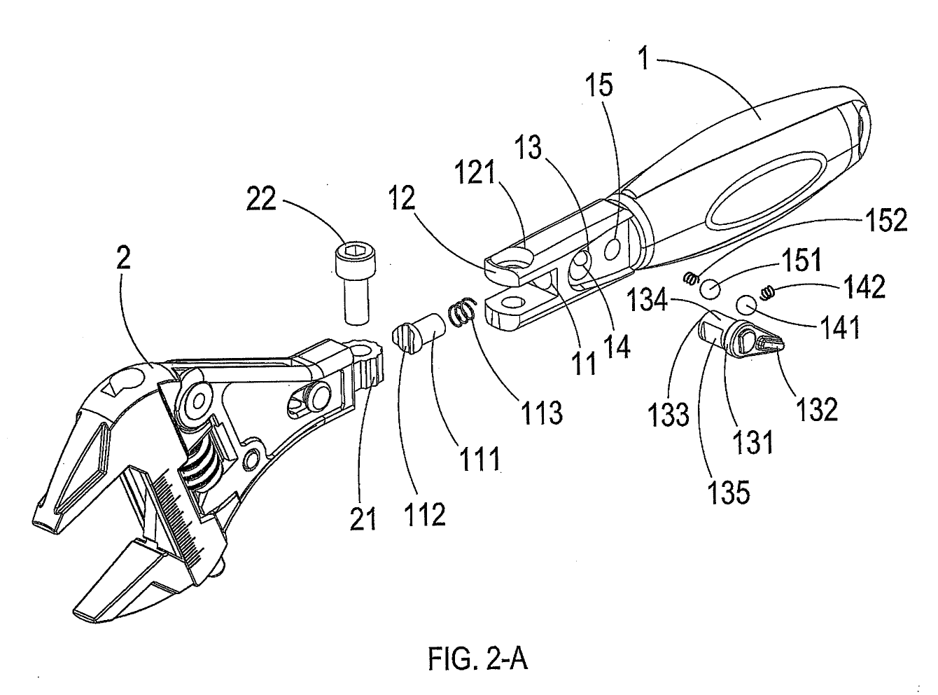

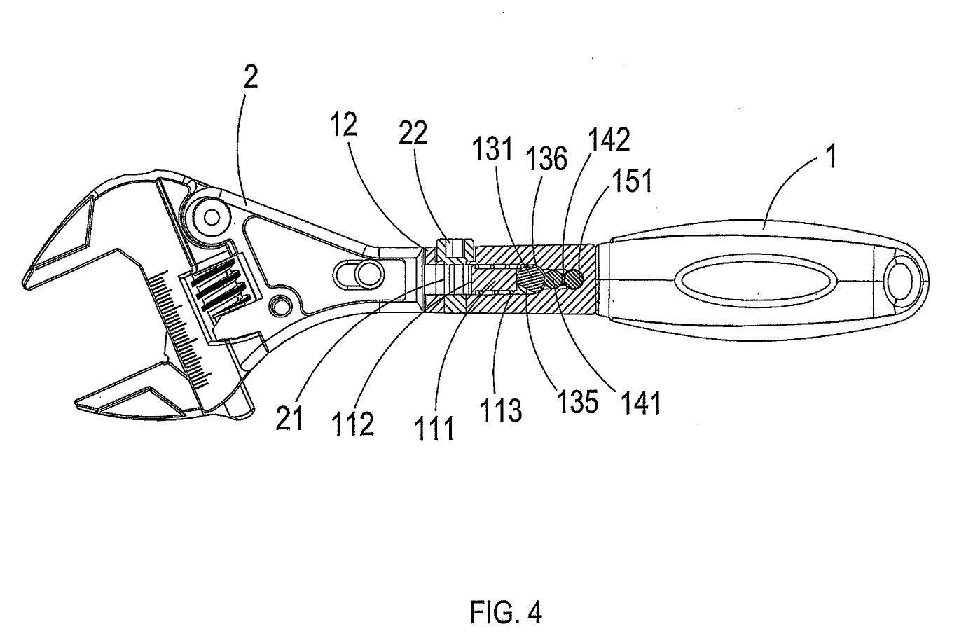

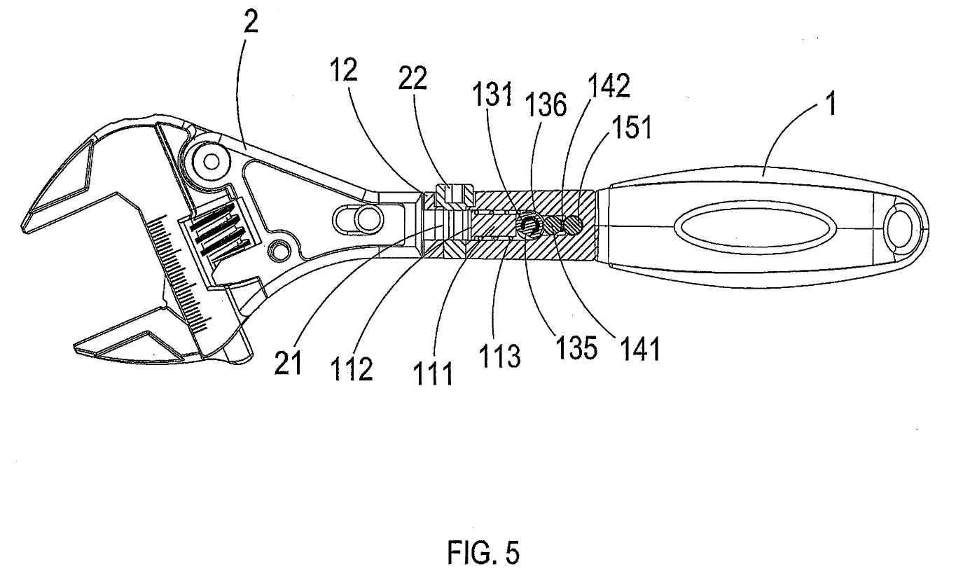

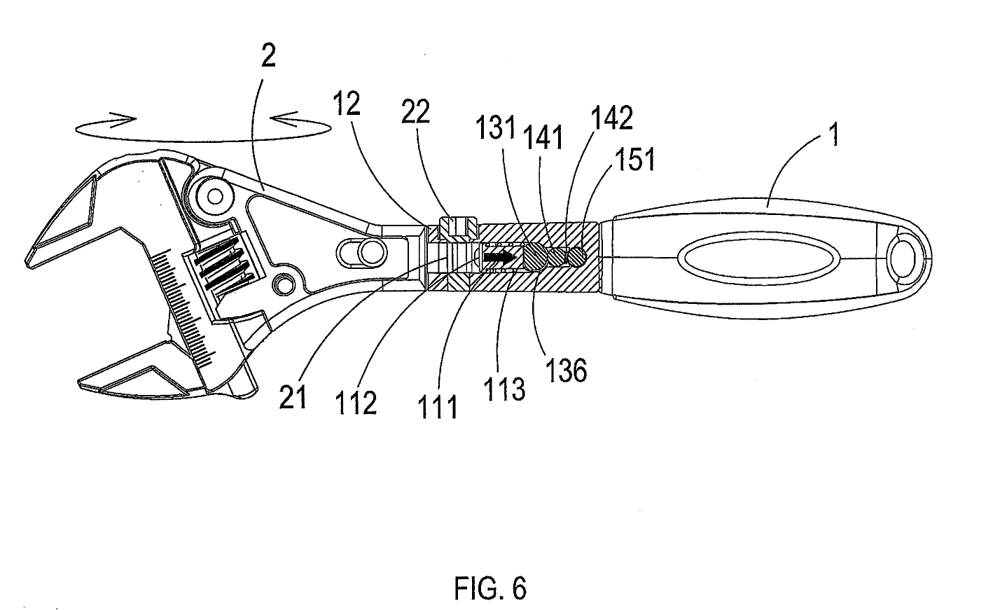

Referring to FIGS. 2, 2A, 4, 5 and 6 at a same time, it shows a first three-dimensional exploded view, a second three-dimensional exploded view, a first schematic view of an operation, a second schematic view of an operation and a third schematic view of an operation, of a preferred embodiment of the present invention. As shown in the drawings, the present invention includes the knob 131 which uses the ball 141 in the locking groove 14 to lock the knob 131 in the control slot 13. Besides, the ball 141 in the locking groove 14 is also abutted with the elastic element 142, allowing the knob 131 to be more effectively locked in the control slot 13. Moreover, the actuating slot 11 of the present invention is provided with the actuating rod 111 and the end of the actuating rod 111 is formed with the teeth part 112 which can be locked with the swiveling head 2; therefore, when a user rotates the knob 131 to let the wall 134 of the knob 131 to push the actuating rod 111, the teeth part 112 of the actuating rod 111 will be locked with the teeth part 21 of the swiveling head 2. At this time, the swiveling head 2 can be fixed at a constant position.

On the other hand, when the user rotates the knob 131 that the actuating rod 111 corresponds exactly to the notch 135 of the actuating part 133, one end of the actuating rod 111 will be accommodated in the notch 135, and at a same time, the teeth part 112 of the actuating rod 111 will be away from the teeth part 21 of the swiveling head 2. At this time, the swiveling head 2 can rotate freely.

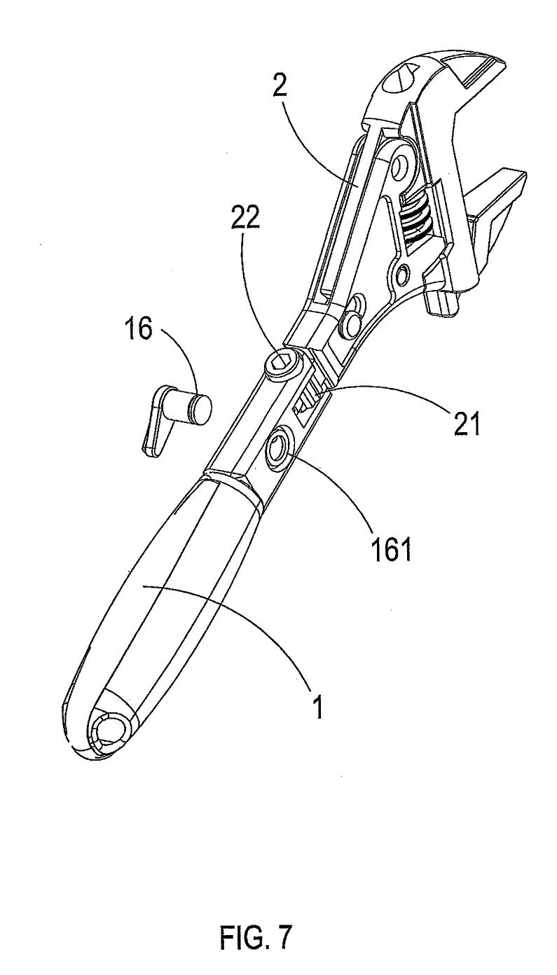

Referring to FIGS. 2, 2A and 7 at a same time, it shows a first three-dimensional exploded view and a second three-dimensional exploded view of a preferred embodiment of the present invention, as well as a schematic view of an implementation of another preferred embodiment of the present invention. As shown in the drawings, the actuating part 133 of the present invention is formed with a ring groove 16, the control slot 13 is surrounded by a collar 161 and the collar 161 can be locked into the ring groove 16. By the aforementioned structures, the knob 131 is effectively fixed in the control slot 13 by locking the collar 161 with the ring groove 16.

Furthermore, the swiveling head 2 of the present invention can be any kind of hand tool (such as an F-handle, a screw driver set or a sleeve set).

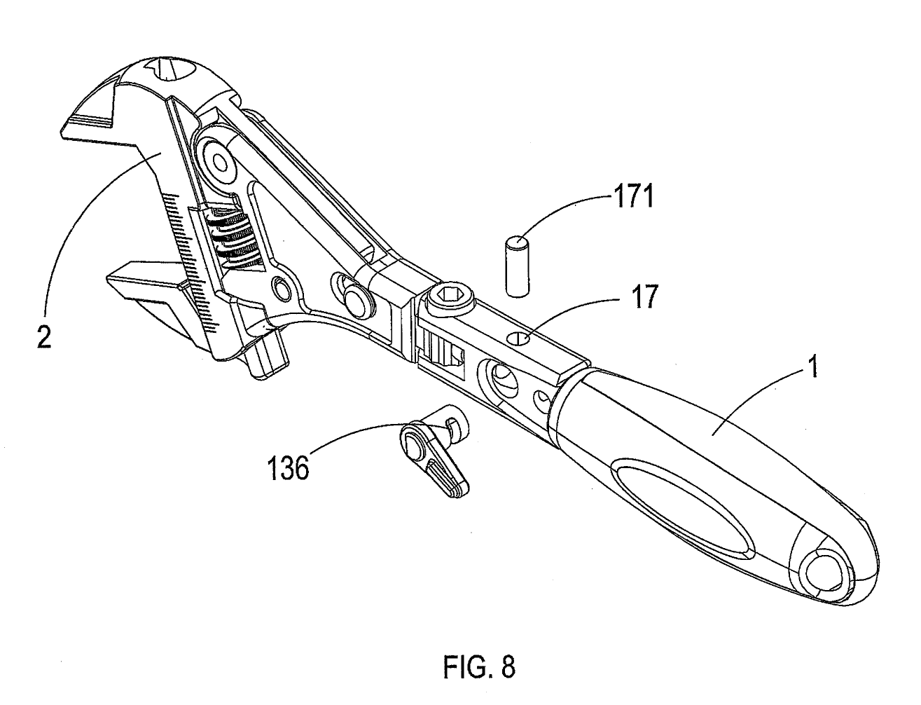

Referring to FIGS. 2, 2A and 8, it shows a first three-dimensional exploded view and a second three-dimensional exploded view of a preferred embodiment of the present invention, as well as a schematic view of an implementation of still another preferred embodiment of the present invention, wherein the side wall of the grip part 1 of the present invention can be provided with a latch slot 17 into which is accommodated with a latch pin 171, and the actuating part 133 is formed with a latching groove 136 which can accommodate the latch pin 171.

By the aforementioned structures, a solution is provided to lock the knob 131 in the control slot 13, as well.

Accordingly, referring to all the drawings, the present invention is actually provided with following advantages when compared with the prior art.

The knob 131 of the present invention includes the toggle part 132 which can rotate the knob 131, and the actuating part 133; wherein, the side walls of the actuating part 133 are formed respectively with the wall 134 which can push the actuating rod 111 away from the actuating slot 11, and the notch 135 which can accommodate the actuating rod 111 that the actuating rod 111 can be received in the actuating slot 11. Therefore, when the user toggles the knob 131 to fix the swiveling head 2 at a fixed position, he or she only needs to toggle the knob 131 to enable the wall 134 of the actuating part 133 to push the actuating rod 111; and when the teeth part 112 of the actuating rod 111 is locked with the teeth part 21 of the swiveling head 2, the swiveling head 2 can be fixed. On the other hand, when the user toggles the knob 131 to rotate the swiveling head 2 freely, he or she only needs to toggle the knob 131, enabling the notch 135 of the actuating part 133 to align with the actuating rod 111 that one end of the actuating rod 111 is accommodated in the notch 135; at this time, the teeth part 112 will be away from the teeth part 21 of the swiveling head 2, and the user can rotate the swiveling head 2 freely to reach to a necessary position.

It is of course to be understood that the embodiments described herein is merely illustrative of the principles of the invention and that a wide variety of modifications thereto may be effected by persons skilled in the art without departing from the spirit and scope of the invention as set forth in the following claims.

What is claimed is:

1. A bending structure of a hand tool comprising a grip part, a bottom rim of an end of which is formed with an actuating slot, an interior of the actuating slot being slidingly provided with an actuating rod and an end of the actuating rod being formed with a teeth part; two sides of an end of the grip part being extended respectively with a pivoting part, each pivoting part being opened with a pivot hole in a direction perpendicular to the actuating slot, the pivot holes being pivoted with a swiveling head and a rear end of the swiveling heat being formed with a teeth part which is locked with the actuating rod; a side of the grip part being opened with a control slot, an interior of the control slot being accommodated with a knob which includes a toggle part to rotate the knob and an actuating part; side walls of the actuating part being formed respectively with a wall which pushes the actuating rod away from the actuating slot and a notch which accommodates the actuating rod to receive the actuating rod in the actuating slot.

2. The bending structure of a hand tool according to claim 1, wherein an elastic element is provided between the actuating rod and the actuating part.

3. The bending structure of a hand tool according to claim 1, wherein the swiveling head is pivoted at the pivot holes with a screw element.

4. The bending structure of a hand tool according to claim 1, wherein the control slot is opened with a locking groove in a direction perpendicular to the inner wall, an interior of the locking groove is accommodated with a ball, the ball is abutted with an elastic element and the actuating part is formed with a latching groove to accommodate the ball.

5. The bending structure of a hand tool according to claim 1, wherein a side wall of the grip part is opened with a locking groove into which is accommodated with a ball to lock the toggle part, with the ball being abutted with an elastic element.

6. The bending structure of a hand tool according to claim 1, wherein the actuating part is formed with a ring groove and the control slot is provided with a collar which is locked into the ring groove.

7. The bending structure of a hand tool according to claim 1, wherein a side wall of the grip part is provided with a latch slot into which is accommodated with a latch pin and the actuating part is formed with a latching groove slot to accommodate the latch pin.
